(19) United States
(12) Patent Application Publication
(10) Pub. No.: US 2006/0044836 A1
(43) Pub. Date: Mar. 2, 2006

(54) Backlight modules and assembly methods thereof

(75) Inventors: Chun-Yuan Chen, Lujhu Township (TW); Wen-Yuan Cheng, Yangmei Township (TW); Kun-Hung Hsieh, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/032,568

(22) Filed: Jan. 10, 2005

(30) Foreign Application Priority Data
Sep. 1, 2004 (TW) 93126327

(51) Int. Cl. F21V 7/04

(52) U.S. Cl. 362/632

(57) ABSTRACT

Backlight modules and assembly methods thereof are provided. A backlight module includes a light guide plate, a lamp module, and two locating members. The lamp module includes a first end, a second end. Each locating member is disposed on the first end and the second end respectively. The lamp module is disposed on the light guide plate by abutting the locating members and the light guide plate.

### BACKGROUND

The invention relates to methods of backlight module assembly, and in particular, to methods capable of assembling a lamp module to an assembled side of a light guide plate in a direction substantially perpendicular to the assembled side.

Optical characteristics of backlight modules may be determined by the positional relationship between the lamp module and the light guide plate.

Referring to FIGS. 1a-1d, in a conventional backlight module, the lamp module is slidably disposed on the light guide plate for assembly. Specifically, the lamp module 1 is slid along an edge of the light guide plate 2 in the direction shown by arrow A in FIG. 1b. When sliding the lamp module 1, the side of the light guide plate 2 may be damaged by friction. Furthermore, the lamp module 1 includes only one locating member 1b formed on a bushing 1a at one end thereof. Thus, the lamp module 1 may not be accurately aligned with the light guide plate 2 by a single locating member 1b.

### SUMMARY

A backlight module is provided. An exemplary embodiment of a backlight module comprises a light guide plate, a lamp module and two locating members. The lamp module has a first end, a second end. Each locating member is disposed on the first end and the second end respectively. The lamp module is disposed on the light guide plate by the locating members abutting the light guide plate.

Furthermore, some embodiments of a lamp module comprise two bushings disposed on the first end and the second end to correspond to the locating members respectively. Each locating member is protruded from the corresponding bushing to form a stepped portion to abut the light guide plate.

Alternatively, some embodiments of a lamp module further comprise a housing on which the locating members are disposed.

Moreover, some embodiments of a light guide plate are substantially rectangular. The locating members abut corners of the light guide plate at the same side of the light guide plate.

Assembly methods are also provided. An exemplary embodiment of a method for assembling a backlight module, comprises the following steps. A frame, a light guide plate, and a lamp module are provided, wherein the lamp module has a first end, a second end, and a plurality of locating members are disposed on the first end and the second end respectively. The lamp module and the light guide plate are assembled by abutting the locating members and the light guide plate. The assembly of the lamp module and the light guide plate is placed into the frame.

Furthermore, some embodiments of a lamp module are assembled to the light guide plate in a direction substantially perpendicular to a side to be assembled of the light guide plate.

Some embodiments of methods for assembling a backlight module, comprise the following steps. A frame, a light guide plate, and a lamp module are provided, wherein the lamp module has a first end, a second end, and a plurality of locating members are disposed on the first end and the second end respectively. The lamp module is placed into the frame. The light guide plate is placed into the frame to assemble the lamp module and the light guide plate by abutting the locating members and the light guide plate.

Furthermore, some embodiments of a lamp module comprise a housing that does not interfere with the light guide plate when placing the light guide plate into the frame.

### DESCRIPTION OF THE DRAWINGS

Backlight modules and assembly methods thereof can be more fully understood by reading the subsequent detailed description and examples with references made to the accompanying drawings, wherein:

FIG. 1a is an exploded view of a conventional backlight module;

FIG. 1b is a schematic view of the conventional backlight module in FIG. 1a during assembly;

FIG. 1c is a schematic view of the assembled backlight module in FIG. 1a, wherein a housing of a lamp module in FIG. 1a is omitted;

FIG. 1d is a partial enlarged view of a portion B in FIG. 1c;

FIG. 2a is an exploded view of an embodiment of a backlight module;

FIG. 2b is a schematic view of the assembled backlight module in FIG. 2a, wherein a housing of a lamp module in FIG. 2a is omitted;

FIG. 2c is a partial enlarged view of a portion D in FIG. 2b;

FIG. 2d is a partial cross section of the assembly of a lamp module and a light guide plate in FIG. 2a;

FIGS. 3a and 3b depict an embodiment of a method for assembling a backlight module;

FIG. 4 is a partial cross section depicting another lamp module and the light guide plate; and

FIGS. 5a and 5b depict an embodiment of a method for assembling a backlight module.

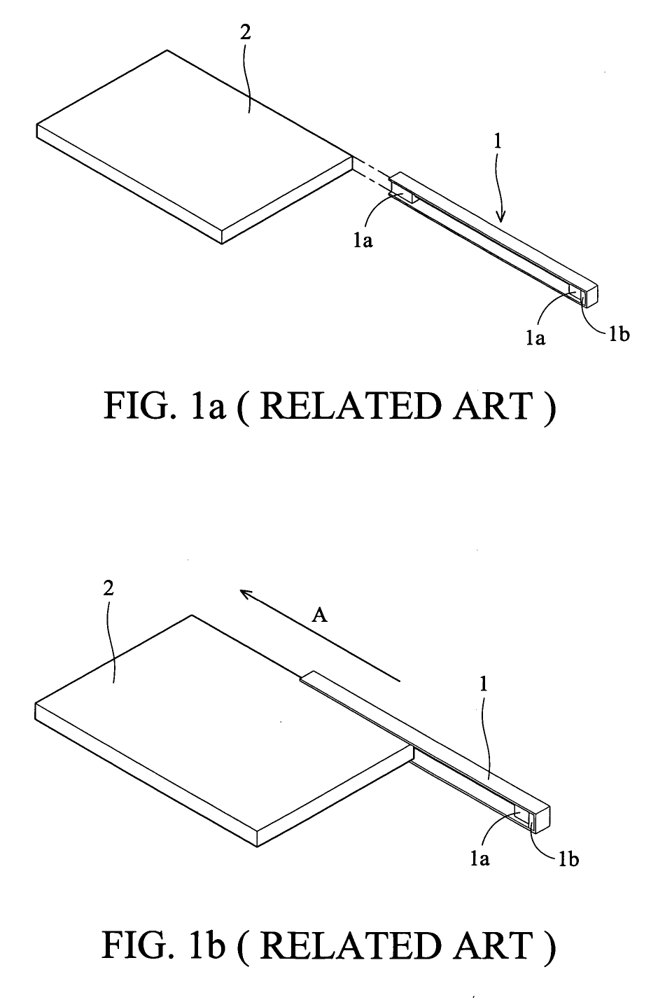

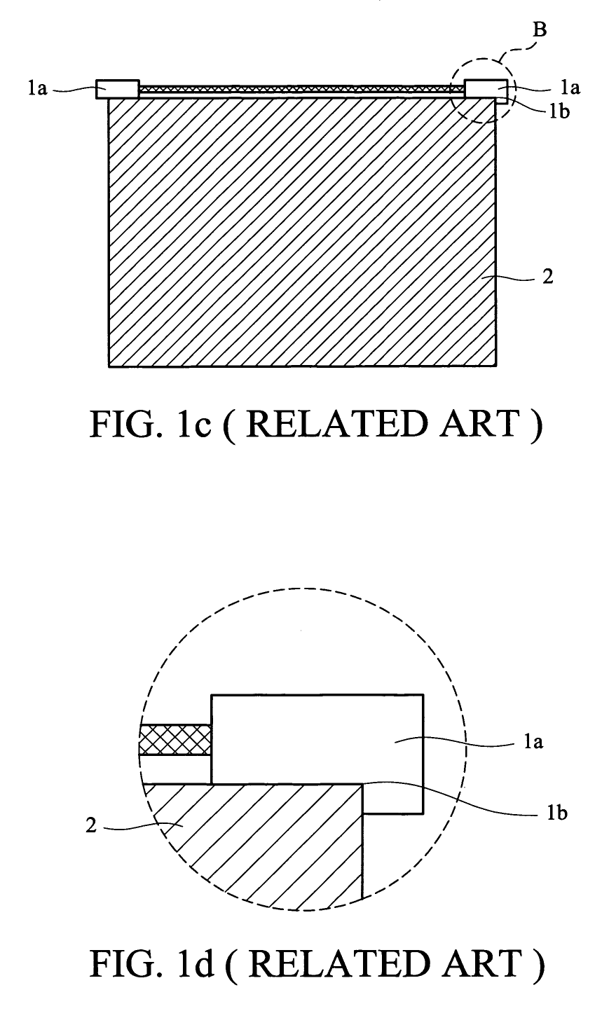

### DETAILED DESCRIPTION

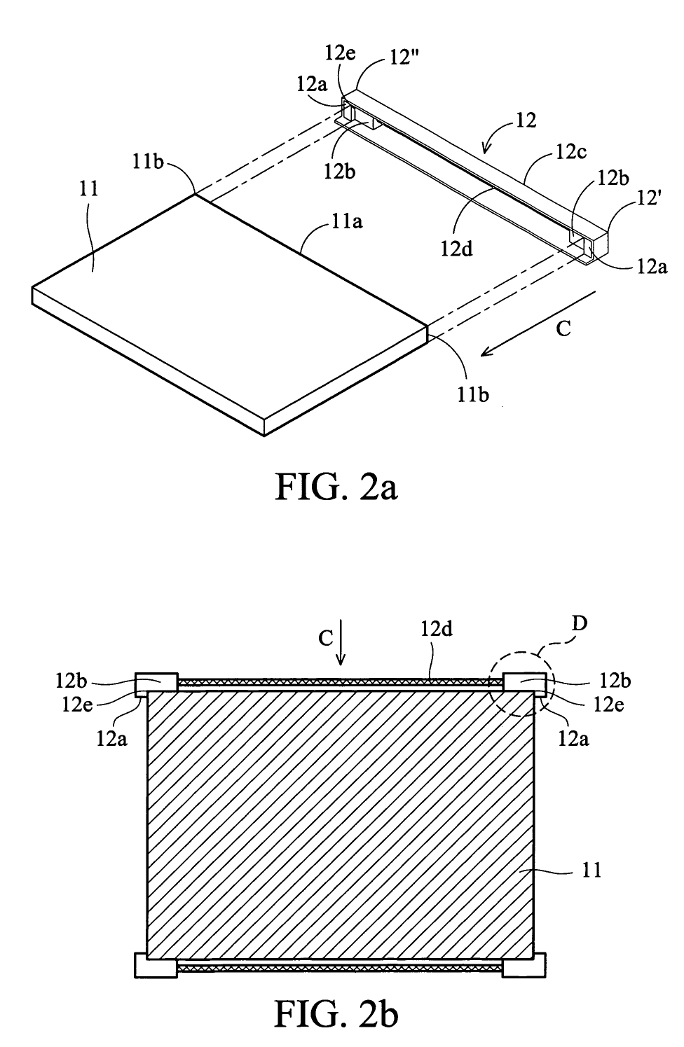

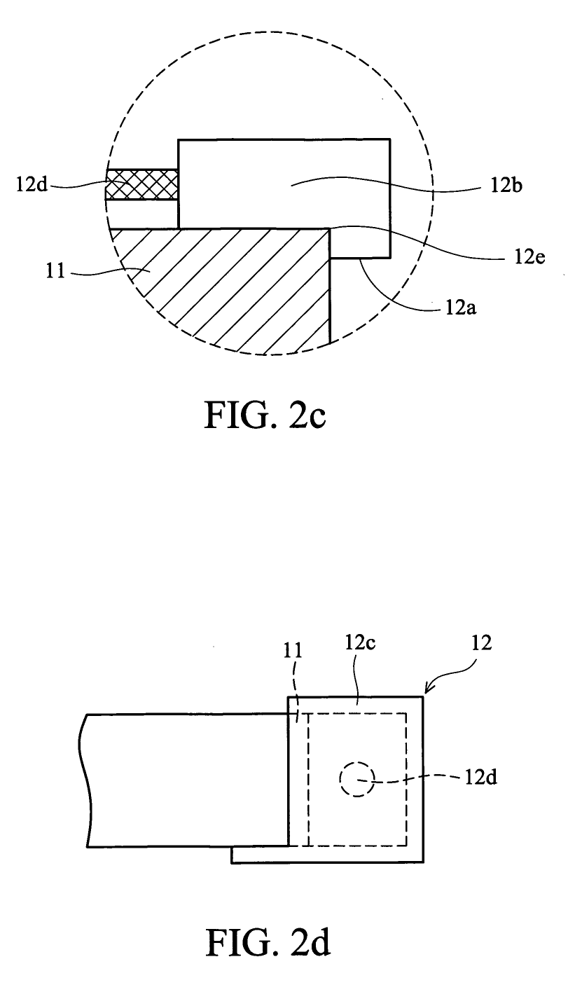

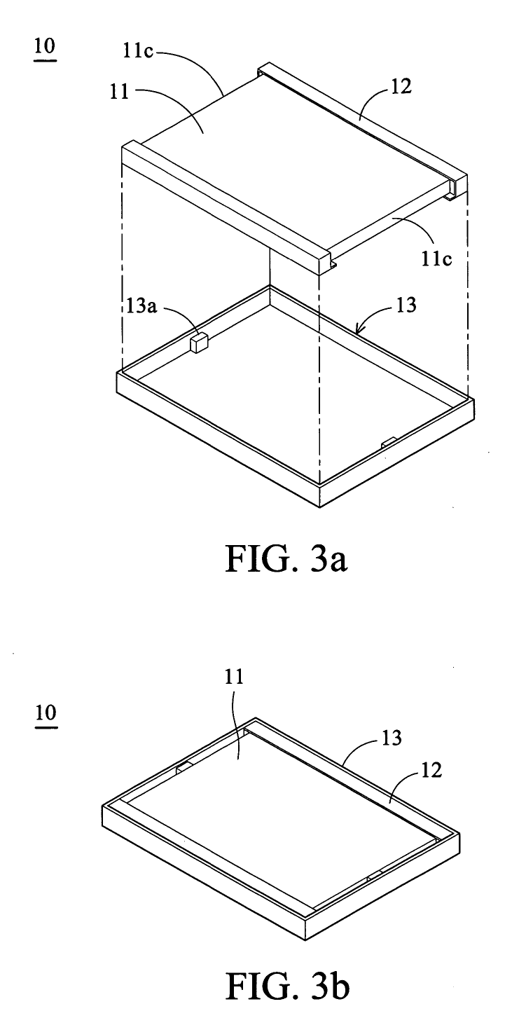

FIGS. 2a, 2b, 2c, and 3a depict an embodiment of a backlight module 10 comprising a light guide plate 11, two lamp modules 12, and a frame 13. The lamp modules 12 are disposed on opposite sides of the light guide plate 11 respectively. Only one lamp module 12 is shown in FIG. 2a for simplicity.

The light guide plate 11 is substantially rectangular, and comprises four corners 11b. Each lamp module 12 comprises a first end 12′, a second end 12″, two locating members 12a, two bushings 12b, a housing 12c, and a tube 12d. The bushings 12b are disposed on both ends of the housing 12c respectively to locate the tube 12d. Each locating member 12a corresponds to the bushing 12b respectively, and is integrally formed on the corresponding bushing 12b. Each lamp module 12 is disposed on the light guide plate 11 by abutting the locating members 12a and the corners 11b of an assembled side 11a of the light guide plate 11. As shown in FIG. 2b, each locating member 12a is protruded from the corresponding bushing 12b to form a stepped portion 12e to abut the light guide plate 11. While in some embodiments, the locating member 12a is integrally formed on the bushing 12b, it is not limited thereto, and may be disposed on the housing 12c.

As stated above, since an embodiment of the lamp module comprises the locating members at both ends, it can be accurately located on the light guide plate, thus obtaining better optical performance.

To assemble the backlight module 10, the lamp modules 12 are first installed on the light guide plate 11 by abutting the locating members 12a of the lamp module 12 and the corners 11b the light guide plate 11, as shown in FIG. 3a. Each lamp module 12 is assembled to the light guide plate 11 in a direction by arrow C in FIG. 2a. That is, the assembly direction of each lamp module 12 is substantially perpendicular to the assembled side 11a of the light guide plate 11. Then, the lamp module 12 and the light guide plate 11 assembly is placed into the frame 13, as shown in FIG. 3b. The frame 13 comprises flanges 13a to locate sides 11c of the light guide plate 11.

As previously stated, since the lamp module comprises the locating members at both ends, the lamp module may be placed into the frame after installing on the light guide plate. Conversely, the conventional lamp module with one locating member may not be placed into the frame after assembly with the light guide plate. Furthermore, since the lamp module is directly assembled to the side of the light guide plate, the assembly processes may be simplified and the assembly difficulties may be reduced. Additionally, since the lamp module is disposed on the light guide plate without sliding, the light guide plate may avoid damages by the friction of the lamp module.

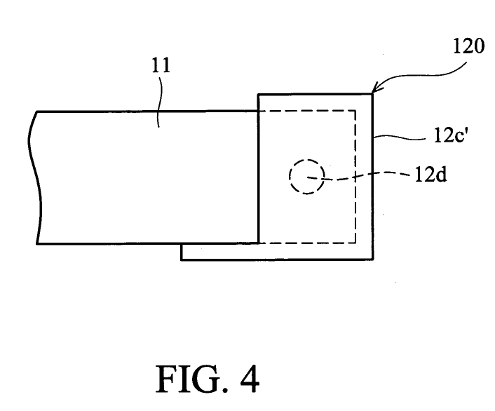

FIG. 2d depicts the relationship between the housing 12c of the lamp module 12 and the light guide plate 11. While an upper portion of the housing 12c is partially overlapped with an upper surface of the light guide plate 11 in FIG. 2d, it is not limited thereto. For example, FIG. 4 depicts another lamp module 120. An upper portion of a housing 12c′ of the lamp module 120 is not overlapped with the upper surface of the light guide plate 11.

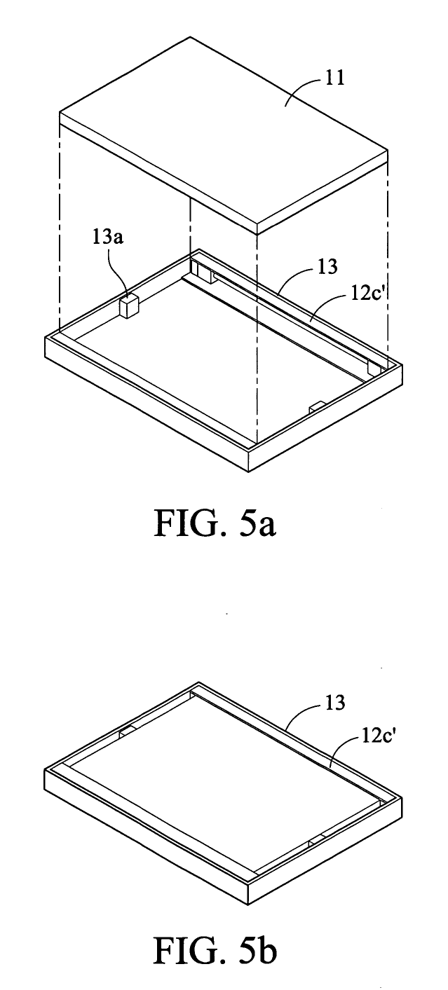

To assemble a backlight module with the lamp module 120, the lamp module 120 is first placed into the frame 13, as shown in FIG. 5a. The light guide plate 11 is then placed into the frame 13, and the lamp module 120 is combined with the light guide plate 11 by abutting the locating members 12a and the light guide plate 11.

As stated above, since the upper portion of the housing 12c′ of the lamp module 120 does not overlap the upper surface of the light guide plate 11, the housing 12c does not interfere with the light guide plate 11 when placing the lamp module 120 into the frame 13. Additionally, since the lamp module is disposed on the light guide plate without sliding, the light guide plate may avoid damages by the friction of the lamp module.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module comprising:
a light guide plate;
a lamp module having a first end and a second end; and
two locating members, each being disposed on the first end and the second end, respectively;
wherein the lamp module is disposed on the light guide plate by abutting the locating members and the light guide plate.

2. The backlight module as claimed in claim 1, wherein the lamp module further comprises two bushings, each being disposed on the first end and the second end to correspond to the locating members respectively.

3. The backlight module as claimed in claim 2, wherein each locating member is protruded from the corresponding bushing to form a stepped portion to abut the light guide plate.

4. The backlight module as claimed in claim 1, wherein the lamp module further comprises a housing on which the locating members are disposed.

5. The backlight module as claimed in claim 1, wherein the light guide plate is substantially rectangular, and the locating members abut corners of the light guide plate at the same side of the light guide plate.

6. A method for assembling a backlight module, comprising:
providing a frame, a light guide plate, and a lamp module, wherein the lamp module has a first end, a second end, and a plurality of locating members are disposed on the first end and the second end, respectively;
assembling the lamp module and the light guide plate by abutting the locating members and the light guide plate; and
placing the assembly of the lamp module and the light guide plate into the frame.

7. The method as claimed in claim 6, wherein the lamp module is assembled to the light guide plate in a direction substantially perpendicular to a side to be assembled of the light guide plate.

8. A backlight module comprising:
a light guide plate; and
at least one lamp module having a first end and a second end;
wherein the at least one lamp module further comprises:
a housing;
at least two bushings, disposed on the housing, located at the first end and the second end respectively; and
at least two locating members corresponding to the at least two bushings respectively, wherein each locating member is protruded from the corresponding bushing to form a stepped portion to abut the light guide plate.

9. The backlight module as claimed in claim 8, wherein the light guide plate is substantially rectangular, and the at least two locating members abut corners of the light guide plate at the same side of the light guide plate.
